(19) United States
(12) Patent Application Publication
(10) Pub. No.: US 2026/0181308 A1
(43) Pub. Date: Jun. 25, 2026

(54) ACOUSTIC QUALITY EVALUATING APPARATUS, ACOUSTIC QUALITY EVALUATING METHOD, AND PROGRAM

(71) Applicant: NNT, Inc., Tokyo (JP)

(72) Inventors: Sachiko KURIHARA, Musashino-shi, Tokyo (JP); Noriyoshi KAMADO, Musashino-shi, Tokyo (JP)

(73) Assignee: NNT, Inc, Tokyo (JP)

(21) Appl. No.: 19/127,411

(22) PCT Filed: Dec. 7, 2022
(86) PCT No.: PCT/JP2022/045043

§ 371 Date: May 6, 2025

(51) Int. Cl. H04R 1/10; H04M 9/08; H04R 3/02

(52) U.S. Cl. CPC H04R 1/1083; H04M 9/082; H04R 3/02

(57) ABSTRACT

Even in a telephony environment with ambient noise, appropriate acoustic quality evaluation of a loudspeaker hands-free communication system is implemented by a listening test without performing a conversational test.

An acoustic quality evaluation apparatus according to the disclosed technique is an apparatus that evaluates an acoustic quality of the loudspeaker hands-free communication system including a first terminal and a second terminal, and the acoustic quality evaluation apparatus includes a data storage, an acoustic output processor, and a noise output processor. The data storage records an evaluation target sound which is a sound captured by the first terminal and received by the second terminal. The acoustic output processor outputs the evaluation target sound to a head-mounted open type acoustic apparatus. The noise output processor outputs ambient noise surrounding the open type acoustic apparatus.

### TECHNICAL FIELD

The disclosed technique relates to a technique for evaluating a communication quality, and particularly, to a quality evaluation test technique for a loudspeaker hands-free communication system.

### BACKGROUND ART

With the development of a communication technique, there is an increasing opportunity to use a loudspeaker hands-free communication system such as a conference system or a hands-free loudspeaker call using a smartphone since a call can be easily made without holding a device. An acoustic echo canceller (AEC) has been used to remove acoustic echo signal and ambient noise that are problems in the loudspeaker hands-free communication system and to provide a comfortable telephony environment.

FIG. 1 schematically illustrates acoustic echo signal and an AEC.

A near-end talker 101 and a far-end talker 102 communicate with each other using a loudspeaker hands-free communication system. Reference numerals 103 and 104 respectively denote a microphone and a speaker on a near-end talker side, and 105 and 106 respectively denote a microphone and a speaker on a far-end talker side.

“Hello” uttered by the near-end talker 101 is output (107) from the far-end speaker 105 and reaches the ears of the far-end talker 102. In the loudspeaker hands-free communication system, the far-end microphone 106 also picks up the speaker output 107 (wraparound 108).

When the voice “Hello” (acoustic echo signal) of the near-end talker picked up by the far-end microphone 106 is directly transmitted to the near-end, it becomes difficult to talk or causes howling. Therefore, the loudspeaker hands-free communication system includes an AEC 109, and transmits a voice signal obtained by removing or reducing a voice from the near-end talker to the near-end. Note that in a case where the AEC also has a noise cancellation function, noise around the far-end talker is also removed or suppressed.

When the effects of the AEC are weak, the acoustic echo signal remain uncancelled. When the effects of the AEC are too strong, the voice to be transmitted from the far end is also removed, and thus the voice is distorted or eliminated and becomes hard to listen to.

Since the performance of the AEC depends on how precisely the acoustic echo signal is removed, the performance evaluation of the conventional AEC is mainly the objective evaluation (evaluation by a computer or the like) focusing on the amount of the acoustic echo signal removed. The objective evaluation is easy since the evaluation can be performed by computer processing.

However, there has been a problem that the objective evaluation does not always match the quality experienced by a user (also referred to as “quality of experience”) in an actual telephone call.

In order to evaluate the acoustic echo signal or sound processed by the AEC in the subjective evaluation (listening evaluation by a human), it is necessary to perceive the acoustic echo signal, and the evaluation becomes possible only when an evaluator himself or herself talks on the phone. Thus, in the loudspeaker hands-free communication system, such as a hands-free loudspeaker call or the like, quality evaluation by a two-way conversational test has been recommended (see Non-Patent Literature 1). However, there has been a problem that the conversational test requires know-how, takes time and cost, and has low reproducibility.

On the other hand, in a call using a handset, a headset, or the like, a voice transmitted from the far-end is not affected by the voice from near-end talker such as an acoustic echo signal, and only the far-end voice can be evaluated. In this case, the evaluation of the communication quality can be performed by simplifying the conversational test and performing the listening test on the one-way communication, and this test method is common in the communication quality evaluation of the IP phone.

The listening test has higher reproducibility and shorter implementation time than the conversational test.

Therefore, it is highly convenient. Furthermore, an objective evaluation method such as perceptual evaluation of speech quality (PESQ) of estimating a subjective evaluation value obtained by a listening test (also referred to as “Listening MOS”, where MOS represents Mean Opinion Score) has also been established (see Non-Patent Literature 2).

In recent years, a method of applying the subjective evaluation by the listening test and the objective evaluation such as PESQ to a loudspeaker hands-free communication system has also been proposed (Non-Patent Literature 3, Patent Literature 1).

### PRIOR ART LITERATURE

### Patent Literature

Patent Literature 1: JP 2016-46694 A

### NON-PATENT LITERATURE

Non-Patent Literature 1: ITU-T, “ITU-T Recommendation P.800: Methods for subjective determination of transmission quality”, ITU, 1996.

Non-Patent Literature 2: ITU-T, “ITU-T Recommendation P.862: Perceptual evaluation of speech quality (PESQ): An objective method for end-to-end speech quality assessment of narrow-band telephone networks and speech codecs”, ITU, 2002.

Non-Patent Literature 3: Sachiko Kurihara, Suehiro Shimauchi, Masahiro Fukui, Noboru Harada, “Quality of experience assessment in hands-free communications—Study on subjective evaluation method consistent with PESQ measure—”, IEICE Technical Report, vol. 117, no. 386, CQ2017-96, pp. 63-68, January 2018.

### SUMMARY OF THE INVENTION

### Problems to be Solved by the Invention

With the spread of a smartphone, a PC, and the like, there are more opportunities to have a hands-free loudspeaker call under ambient noise. The ambient noise refers to, for example, an air-conditioning sound in an office, a sound inside a vehicle traveling, a traveling sound of a vehicle at an intersection, a sound of an insect, a touch sound of a keyboard, a machine sound in a factory, a plurality of human voices (chattering sound), and the like, regardless of the magnitude of the sound, indoor place or outdoor place.

However, an acoustic quality evaluation method for the loudspeaker hands-free communication system under such ambient noise has not yet been established.

When the near-end talker is in a “quiet environment”, the speaker output sound (voice of the far-end talker, noise around the far-end talker, an acoustic echo signal, voice distortion of the far-end talker due to AEC processing, a residual echo, and the like) from a far-end terminal is easy to perceive even in details.

Therefore, even when there is slight distortion or noise superimposition, the low evaluation is obtained.

On the other hand, when the near-end talker is in an “environment with ambient noise”, the speaker output sound from the far-end terminal is masked by the “noise around the near-end talker”, and noise (noise around a far-end talker and an acoustic echo signal, voice distortion of the far-end talker due to AEC processing, residual echo, and the like) from the far-end terminal is hard to listen to. Therefore, even when there is some distortion or noise superimposition, the influence on the evaluation tends to be small, and the evaluation tends to be higher than the evaluation “when the near-end talker is in a quiet environment”.

As described above, when the near-end talker is “in a quiet environment without ambient noise” and “in an environment with ambient noise”, the evaluation on the output sound differs even when the output sound (=evaluation target sound) from the speaker is the same.

As described above, these environmental evaluations could only be carried out in conversational tests.

An object of the disclosed technique is to implement an acoustic quality evaluation technique capable of obtaining an appropriate evaluation value by a listening test without performing a conversational test even in a telephony environment with ambient noise.

### Means to Solve the Problems

In order to solve the above problem, according to the disclosed technique, there is provided an acoustic quality evaluation apparatus that evaluates an acoustic quality of a loudspeaker hands-free communication system including a first terminal and a second terminal, the acoustic quality evaluation apparatus including a data storage, an acoustic output processor, and a noise output processor.

The data storage records a sound received by the first terminal and an evaluation target sound received by the second terminal.

The acoustic output processor outputs the evaluation target sound to a head-mounted open type acoustic apparatus.

The noise output processor outputs ambient noise surrounding the open type acoustic apparatus.

### Effects of the Invention

According to the disclosed technique, even in a telephony environment with ambient noise, it is possible to realize appropriate acoustic quality evaluation of a loudspeaker hands-free communication system by a listening test without performing a conversational test.

### BRIEF DESCRIPTION OF THE DRAWINGS

FIG. 1 is a diagram schematically illustrating acoustic echo signal and an AEC.

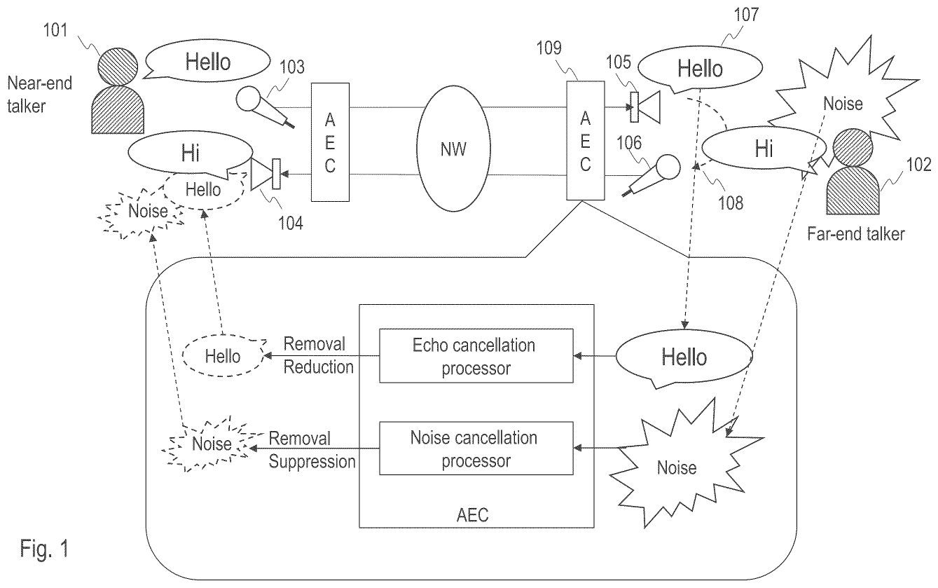

FIG. 2 is a diagram for describing an acoustic quality evaluation test by a listening test in a loudspeaker hands-free communication system.

FIG. 3 is a functional block diagram of an acoustic quality evaluation system according to the first embodiment.

FIG. 4 is a functional block diagram of a data generation apparatus according to the first embodiment.

FIG. 5 is a flowchart illustrating an operation of a near-end system of a data generation apparatus.

FIG. 6 is a flowchart illustrating an operation of a far-end system of a data generation apparatus.

FIG. 7 is a flowchart illustrating an operation of a data recording system of a data generation apparatus.

FIG. 8 is a functional block diagram of an acoustic quality evaluation apparatus according to the first embodiment.

FIG. 9 is a flowchart illustrating an operation of an acoustic quality evaluation apparatus.

FIG. 10 is a diagram illustrating a screen example of a display.

FIG. 11 is a diagram illustrating an example of a listening test room.

FIG. 12 is a diagram illustrating second example of a listening test room.

FIG. 13 is a diagram illustrating third example of a listening test room.

FIG. 14 is a diagram illustrating a functional configuration example of a computer.

### DETAILED DESCRIPTION OF THE EMBODIMENTS

Hereinafter, embodiments of the disclosed technique will be described in detail. Note that components having the same functions are denoted by the same reference numerals, and redundant description will be omitted.

### Overview of Listening Test

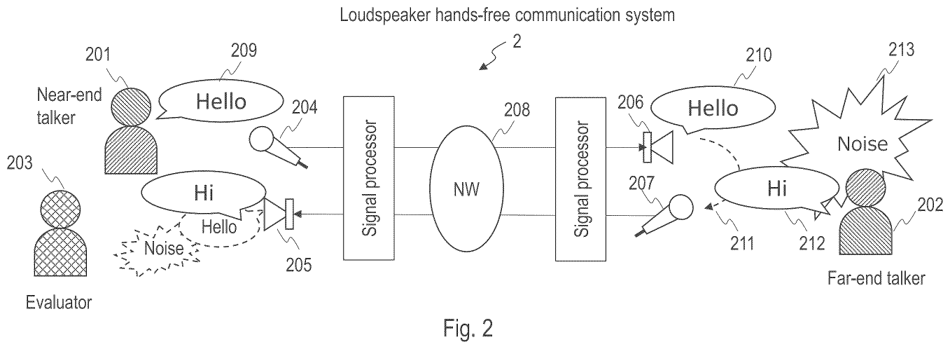

First, an acoustic quality evaluation test by a listening test in a loudspeaker hands-free communication system is conceptually described with reference to FIG. 2. In this acoustic quality evaluation test, a near-end talker 201 and a far-end talker 202 have a conversation through a loudspeaker hands-free communication system 2, and an evaluator 203 located at the near-end talker 201 side evaluates the quality of the loudspeaker hands-free communication system 2.

The loudspeaker hands-free communication system is a communication system that transmits and receives an acoustic signal between terminals including a microphone and a speaker, and is a communication system in which at least a part of a sound (for example, 210 “Hello”) output from the speaker of a terminal is captured by the microphone of the terminal (for example, a communication system in which wraparound 211 of the sound occurs).

An example of the loudspeaker hands-free communication system is a voice conference system or a video conference system.

In the loudspeaker hands-free communication system 2, a voice 209 of the near-end talker is captured by a microphone 204 on a near-end talker side, the acoustic signal obtained based on the voice is transmitted to the far-end talker side via a network 208, and the sound represented by the acoustic signal is output from a speaker 206 on a far-end talker side. Furthermore, a voice at the far-end talker side is captured by a microphone 207 at the far-end talker side, the acoustic signal obtained based on the voice is transmitted to the near-end talker side via the network 208, and the sound represented by the acoustic signal is output from a speaker 205 at the near-end talker side.

However, at least a part of the sound output from the speaker 206 at the far-end talker side is also captured by the microphone 207 at the far-end talker side. That is, the sound at the far-end talker side captured by the microphone 207 at the far-end talker side is obtained by superimposing the wraparound 211 (acoustic echo signal) of the voice derived from the near-end talker on a voice 212 “Hi” of the far-end talker. That is, the sound at the far-end talker side captured by the microphone 207 at the far-end talker side is a sound obtained by superimposing the wraparound 211 in which the voice 210 derived from the near-end talker is degraded in a space at the far-end talker side on the voice 212 of the far-end talker. When the near-end talker 201 is not speaking, the wraparound 211 of the voice derived from the near-end talker is not superimposed. Therefore, the voice of the far-end talker is not degraded.

Note that sound degradation at the far-end talker side is also caused by superposition of ambient noise 213 at the far-end talker side.

The acoustic signal transmitted to the near-end talker side may be derived from a processed signal obtained by performing predetermined processing on a signal based on the sound captured by the microphone at the far-end talker side, or may be obtained without performing such signal processing.

An example of the signal processing includes at least one of echo cancellation or noise cancellation. Note that echo cancellation means processing by an echo canceller in a broad sense for reducing an echo. The processing by the echo canceller in a broad sense means overall processing for reducing the echo. For example, the processing by the echo canceller in a broad sense may be implemented only by the echo canceller in a narrow sense using an adaptive filter, may be implemented by a voice switch, may be implemented by echo reduction, may be implemented by a combination of at least some of these techniques, or may be implemented by a combination with other techniques (see Reference 1 below).

Furthermore, the noise cancellation means processing of suppressing or removing a noise component caused by any ambient noise other than the voice of the far-end talker, which is generated around the microphone of the far-end terminal (see Reference 2 below).

[Reference 1] Knowledge base, Forest of knowledge, Group 2, volume 6, Chapter 5, “Acoustic Echo Canceller”, The Institute of Electronics, Information and Communication Engineers

[Reference 2] Sumitaka Sakauchi, Yoichi Haneda, Masashi Tanaka, Junko Sasaki, Akitoshi Kataoka, “An Acoustic Echo Canceller with Noise and Echo Reduction”, The transactions of the Institute of Electronics, Information and Communication Engineers, Vol. J 87-A, No. 4, pp. 448-457, April 2004

In particular, the disclosed technique provides an apparatus for a listening test and a method in a situation where there is ambient noise on a near-end talker side.

The technique disclosed in Patent Literature 1 is different in that a listening test is conducted under a quiet environment without noise around a near-end talker.

### First Embodiment

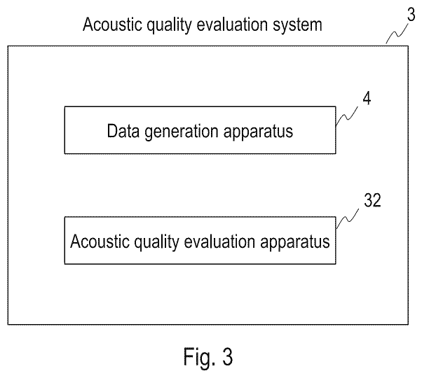

FIG. 3 is a functional block diagram of an example of an acoustic quality evaluation system according to the first embodiment.

An acoustic quality evaluation system 3 includes a data generation apparatus 31 for a test and an acoustic quality evaluation apparatus 32.

### [Data Generation Apparatus]

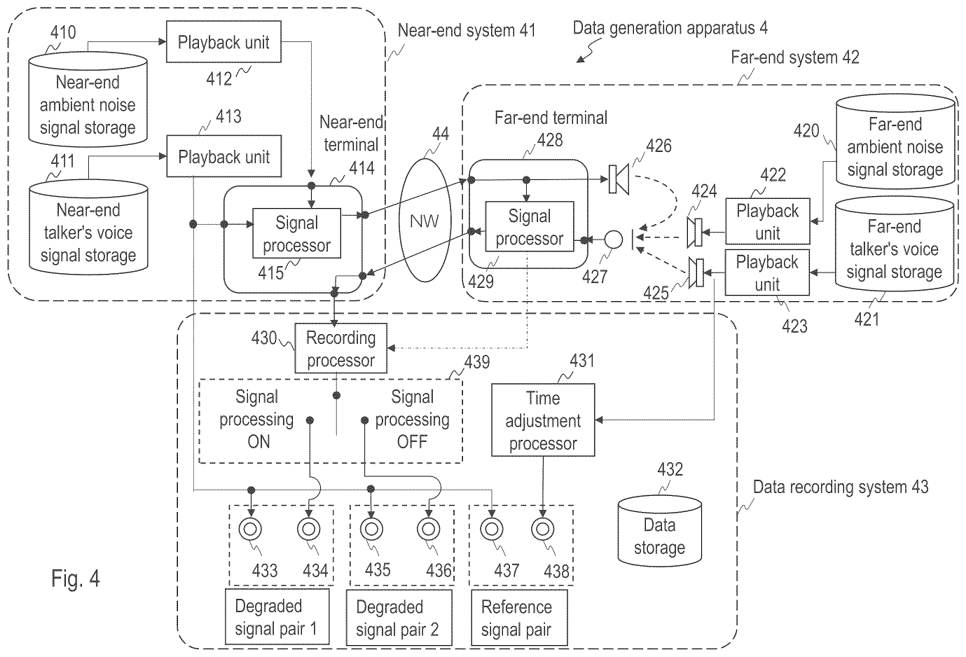

FIG. 4 is a functional block diagram of a data generation apparatus 4 according to the first embodiment. The data generation apparatus 4 includes a near-end system 41 that simulates a near-end talker environment, a far-end system 42 that simulates a far-end talker environment, and a data recording system 43 that records simulated communication between simulation environments.

The near-end system 41 and the far-end system 42 communicate via a network 44. The simulated communication recorded in the data recording system 43 is used in the subsequent acoustic quality evaluation.

### <Near-End System>

The near-end system includes a near-end ambient noise signal storage 410, a near-end talker's voice signal storage 411, playback units 412 and 413, a near-end terminal 414, and a signal processor 415.

### <Far-End System>

The far-end system includes a far-end ambient noise signal storage 420, a far-end talker's voice signal storage 421, playback units 422 and 423, speakers 424, 425, and 426, a microphone 427, a far-end terminal 428, and a signal processor 429.

### <Data Recording System>

The data recording system includes a recording processor 430, a time adjustment processor 431, a data storage 432, data output units 433, 434, 435, 436, 437, and 438, and a switch 439.

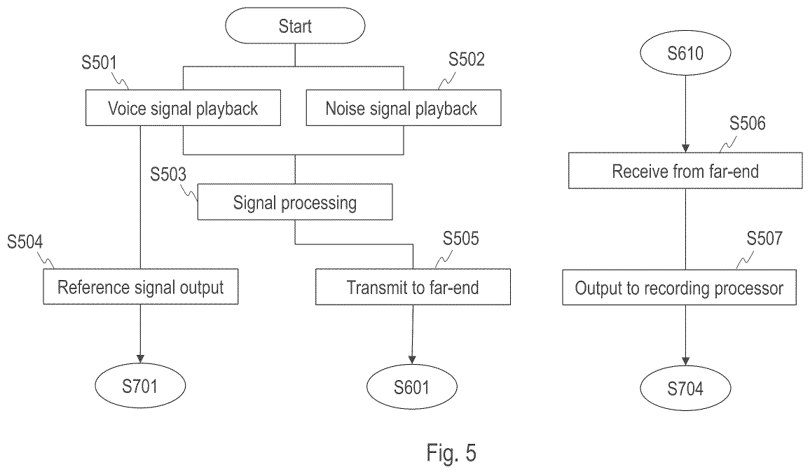

FIGS. 5, 6, and 7 are flowcharts for describing an example of the operation of the data generation apparatus 4.

### <Operation of Near-End System>

The operation of the near-end system will be described with reference to FIGS. 4 and 5.

The data generation apparatus 4 extracts a voice signal from the near-end talker's voice signal storage 411, reproduces the voice signal by using the playback unit 413 (step S501), and inputs the voice signal to the near-end terminal 414. This input corresponds to a voice uttered by a near-end talker. At the same time, the reproduced signal is output to the output units 433, 435, and 437 of the data recording system 43 (step S504). This output (voice uttered by the near-end talker) is a reference sound (to be described later) in a stereo listening test (to be described later).

Furthermore, the data generation apparatus 4 extracts a noise signal from the near-end ambient noise signal storage 410, reproduces the noise signal by using the playback unit 412 (step S502), and inputs the noise signal to the near-end terminal 414. This input corresponds to ambient noise of the near-end talker.

The signal processor 415 performs signal processing (echo cancellation or noise cancellation) on the voice and noise input to the near-end terminal 414 (step S503), and transmits the processed voice and noise to the far-end terminal 428 via the network 44 (step S505).

In parallel, the data generation apparatus 4 outputs the far-end voice received by the near-end terminal to the recording processor 430 of the data recording system (step S507).

<Operation of far-end System>

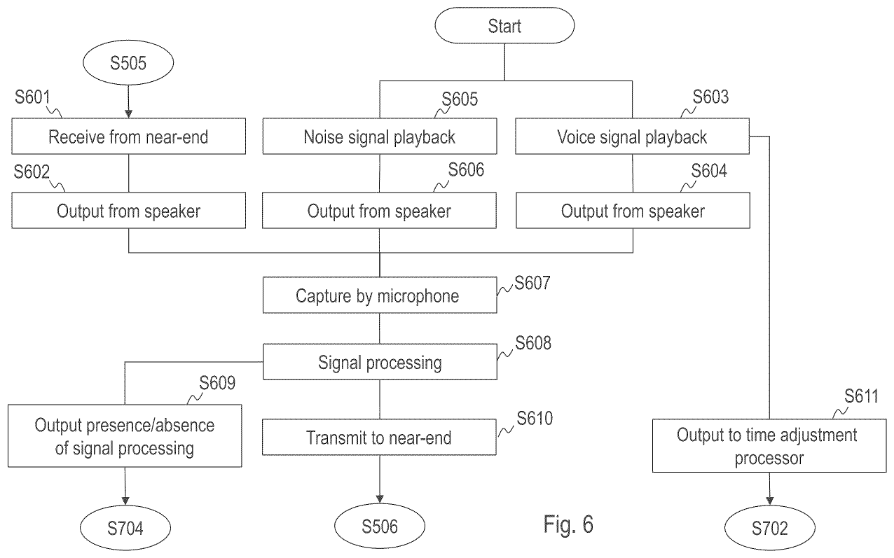

The operation of the far-end system will be described with reference to FIGS. 4 and 6.

The far-end terminal 428 outputs a voice based on the signal received from the near-end terminal from the speaker 426 (step S602). This output corresponds to a voice at the near-end talker side emitted from the loudspeaker hands-free communication system that the far-end talker listens to.

The data generation apparatus 4 extracts a voice signal from the far-end talker's voice signal storage 421, reproduces the voice signal by using the playback unit 423 (step S603), and outputs the voice signal from the speaker 425 (step S604). This output corresponds to a voice uttered by a far-end talker. In parallel, the playback unit 423 outputs the reproduced sound to the time adjustment processor 431 of the data recording system (step S611). This output serves as a non-degraded signal in the subsequent quality evaluation.

Furthermore, the data generation apparatus 4 extracts a noise signal from the far-end ambient noise signal storage 420, reproduces the noise signal by using the playback unit 422 (step S605), and outputs the noise signal from the speaker 424 (step S606). This output corresponds to ambient noise for the far-end talker.

The far-end terminal 428 captures outputs of the speakers 426, 425, and 424 by using the microphone 427 (step S607), and inputs them to the signal processor 429. The signal processor 429 performs signal processing (echo cancellation or noise cancellation) on the input voice signal (voice signal in which the near-end talker's voice, the far-end talker's voice, and the ambient noise are superimposed) as necessary (step S608), and transmits the processed voice signal to the near-end terminal 414 via the network 44 (step S610). At the same time, the signal processor transmits a signal processing presence/absence signal indicating whether or not the signal processing is performed to the recording processor 430 of the data recording system (step S609).

The signal processing presence/absence signal is used when the evaluation target sound is recorded (which will be described later).

### <Operation of Data Recording System>

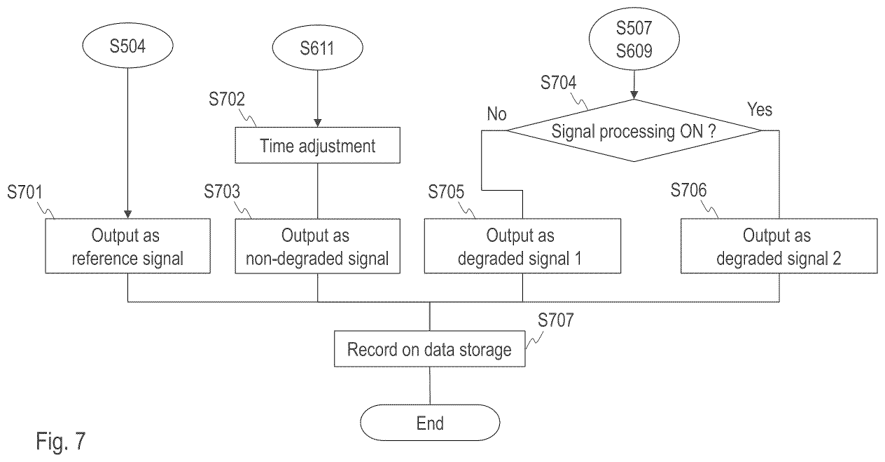

The operation of the data recording system will be described with reference to FIGS. 4 and 7.

The data recording system 43 records the voice output of the near-end system 41 and the voice output of the far-end system 42 in the data storage 432 in order to use them for the later acoustic quality evaluation.

In the acoustic quality evaluation, a far-end talker's voice before echo or noise is superimposed (non-degraded sound) is compared with a sound that is a far-end talker's voice on which echo and noise are superimposed and on which signal processing is not performed (degraded signal 1), and a sound that is a far-end talker's voice on which echo and noise are superimposed and on which signal processing is performed (degraded signal 2).

### <<Stereo Listening Test>>

Furthermore, the test sounds are in stereo configuration so that the evaluator perceives acoustic echo signal during the listening test. The voice (evaluation target sound) at the far-end including the acoustic echo signal is presented to one ear, and the voice (reference sound) at the near-end which is a source of the acoustic echo signal is presented to the other ear, simultaneously. This simulates a state in which an evaluator is present next to the near-end talker who is the source of the acoustic echo signal and the evaluator is listening to a conversation with the far-end talker, and corresponds to representing a conversational test in a pseudo manner.

Although the reference sound and the evaluation target sound may be supplied to any one of the ears, it is desirable to supply the reference sound to, for example, the ear that is not a dominant ear (for example, the right ear) and the evaluation target sound to, for example, the dominant ear (for example, the left ear).

### <<Reference Sound>>

In order to record the voice for evaluation described above, the data generation apparatus 4 outputs the output of the playback unit 413 of the near-end terminal to the output units 433, 435, and 437 as the reference sound of the non-degraded signal, the reference sound of the degraded signal 1, and the reference sound of the degraded signal 2 (step S701), and records the output in the data storage 432 (step S707).

### <<Evaluation Target Sound-Non-Degraded Signal>>

Furthermore, the data generation apparatus 4 applies, to the output of the playback unit 423, a delay corresponding to a delay occurring due to the network by using the time adjustment processor 431 (step S702), outputs the delayed output to the output unit 438 (step S703), and records it in the data storage 432 (step S707). A set of the signal obtained from the output unit 437 and the signal obtained from the output unit 438 is hereinafter referred to as a reference signal pair.

### <<Evaluation Target Sound-Degraded Signal 1>>

The data generation apparatus 4 records the signal received by the near-end terminal 414 in conjunction with the processing of the far-end system.

That is, in a case where the signal processor 429 of the far-end terminal does not perform signal processing such as echo cancellation or noise cancellation, the signal processor 429 outputs a “signal processing OFF signal” to the recording processor 430 (step S609).

The recording processor 430 controls the switch 439 according to the signal processing OFF signal (step S704), and outputs the voice received from the far end to the output unit 434 (step S705). The voice signal output from the output unit 434 is recorded in the data storage 432 (step S707). A set of the voice signal obtained from the output unit 433 and the voice signal obtained from the output unit 434 is hereinafter referred to as a degraded signal pair 1.

### <<Evaluation Target Sound-Degraded Signal 2>>

In a case where the signal processor 429 of the far-end terminal performs signal processing such as echo cancellation or noise cancellation, the signal processor 429 outputs a “signal processing ON signal” to the recording processor 430 (step S609).

The recording processor 430 controls the switch 439 according to the signal processing ON signal (step S704), and outputs the voice received from the far end to the output unit 436 (step S706). The voice signal output from the output unit 436 is recorded in the data storage 432 (step S707). A set of the voice signal obtained from the output unit 435 and the voice signal obtained from the output unit 436 is hereinafter referred to as a degraded signal pair 2.

Note that the degraded signal pair 1 and the degraded signal pair 2 may be collectively referred to as a degraded signal pair.

### [Acoustic Quality Evaluation Apparatus]

The evaluator uses a binaural sound reproduction apparatus such as headphones or earphones, alternately listens to the sound that should be output from the speaker at the near-end talker side in a case where there is no wraparound of the sound at the far-end talker side (that is, the non-degraded sound) and the sound that should be output from the speaker at the near-end talker side in a case where there is the wraparound of the sound at the far-end talker side (that is, the evaluation target sound), and performs subjective evaluation (opinion evaluation) on the communication quality.

Furthermore, the test sound is presented to the evaluator with the above-described stereo configuration. In the present embodiment, the channel of the reference sound is denoted as “Rch”, and the channel of the evaluation target sound is denoted as “Lch”.

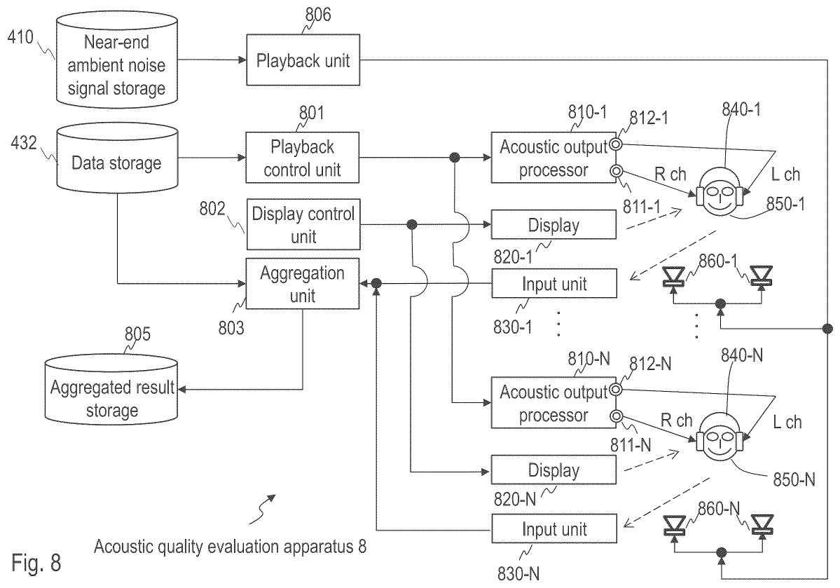

FIG. 8 illustrates a functional block diagram of an acoustic quality evaluation apparatus 8 according to the first embodiment.

The acoustic quality evaluation apparatus 8 can simultaneously perform a test for a plurality of (N) evaluators. Therefore, each of N acoustic output processors, displays, input units, and sound reproduction apparatuses is illustrated as “XXX-1 . . . XXX-N”, and hereinafter, the notation “XXX” without a hyphen collectively refers to N units. For example, the “evaluator 850” collectively refers to the evaluators 850-1 to 850-N.

The acoustic quality evaluation apparatus 8 acquires the test sound from the data storage 432 and the ambient noise from the near-end ambient noise signal storage 410, and supplies the test sound and the ambient noise to the evaluator 850.

The evaluator 850 wears an open-type binaural sound reproduction apparatus (hereinafter, open-type headphones) 840 such as headphones or earphones. Note that the “open type” refers to a structure that has little sound insulation to prevent the reproduced sound from leaking to the outside, and thus, the ambient sound can easily reach the ears of the user of the reproduction apparatus.

Speaker 860 is disposed for the evaluator 850 to supply ambient noise. Note that, as described later, the ambient noise may be presented from a common speaker to a plurality of evaluators, and the number of speakers and the number of evaluators do not necessarily need to match.

The evaluator 850 wears open type headphones 840 and listens to the reference sound and the evaluation target sound in stereo. As described above, since the open type headphones 840 do not block ambient noise, the evaluator 850 listens to the reference sound and the evaluation target sound in an environment with ambient noise.

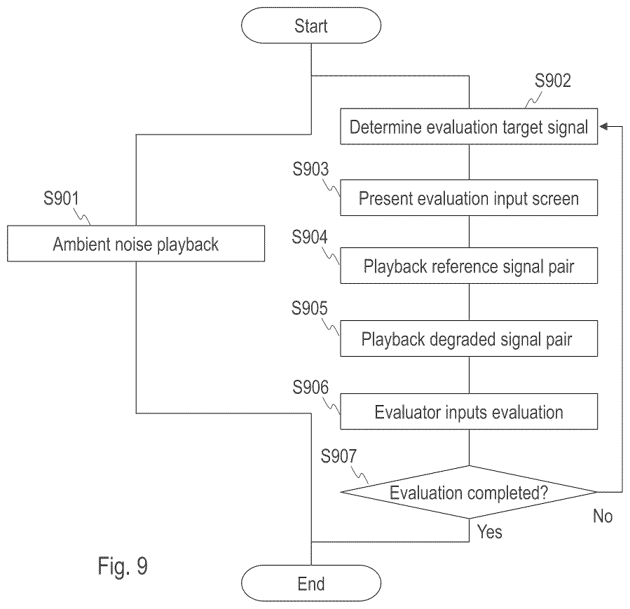

FIG. 9 is a flowchart for describing an example of the operation of the acoustic quality evaluation apparatus 8.

The acoustic quality evaluation apparatus 8 acquires a signal from the near-end ambient noise signal storage 410, reproduces the signal by using a playback unit 806, and outputs the signal from the speaker 860 (step S901).

A playback control unit 801 determines a signal to execute evaluation from among the signals recorded in the data storage (step S902).

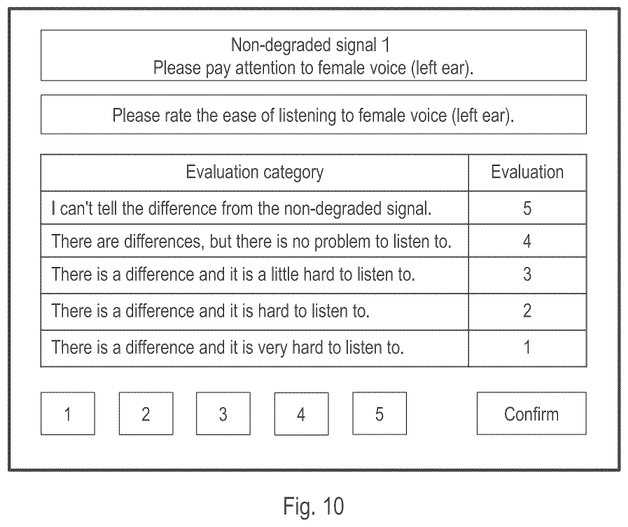

A display control unit 802 displays an evaluation input screen for evaluating the signal determined by the playback control unit on a display 820 (step S903). For example, the evaluation input screen is as illustrated in FIG. 10.

The playback control unit 801 acquires the non-degraded signal pair from the data storage 432 and outputs the non-degraded signal pair from the acoustic output processor 810 to the open type headphones 840 (step S904).

Subsequently, the playback control unit 801 acquires the degraded signal pair from the data storage 432 and outputs the degraded signal pair from the acoustic output processor 810 to the open type headphones 840 (step S905). The evaluator 850 inputs the evaluation using the display 820 and the input unit 830 (step S906).

The acoustic quality evaluation apparatus 8 determines whether all the evaluations are completed, and in a case where all the evaluations are not completed, the acoustic quality evaluation apparatus 8 executes the next evaluation (No in step S907). In a case where all the evaluations are completed, the evaluation procedure ends (Yes in step S907).

An aggregation unit 803 aggregates evaluation results and stores the evaluation results in an aggregation result storage 805.

### Listening Test Room

### <First Example Of Test Room>

The disclosed technique assumes evaluation of the loudspeaker hands-free communication system under ambient noise. In order to simulate a state where the evaluator is under the ambient noise, the listening test is performed in a sealed space such as a soundproof room where speakers are disposed.

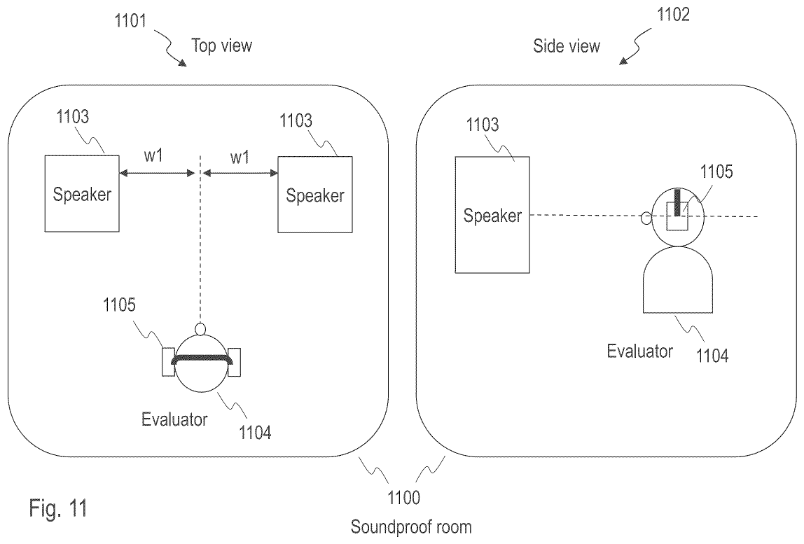

FIG. 11 illustrates an example of a test room for performing the acoustic quality evaluation according to the first embodiment.

The left side 1101 of FIG. 11 is a top view of a soundproof room 1100, and the right side 1102 of FIG. 11 is a side view of the soundproof room 1100. In the soundproof room, an evaluator 1104 wearing open type headphones 1105 is located, a plurality of speakers 1103 are disposed, and the ambient noise is output from the speakers 1103.

At this time, it is desirable that the evaluator is located at substantially equal distances from a plurality of the speakers.

Furthermore, it is desirable that the speaker is sufficiently separated from the evaluator and installed at a position equal to or higher than the height of the ears of the evaluator.

All the speaker outputs may be the same sound (monaural sound) or a stereo sound. In both cases, S/N and volume level are measured near the ears of the evaluator.

Note that the stereo sound refers to a sound that represents the left/right position and the depth of the sound source by cooperation of two speakers, and the actual ambient sound can be more accurately simulated with the stereo sound.

### <Second Example Of Test Room>

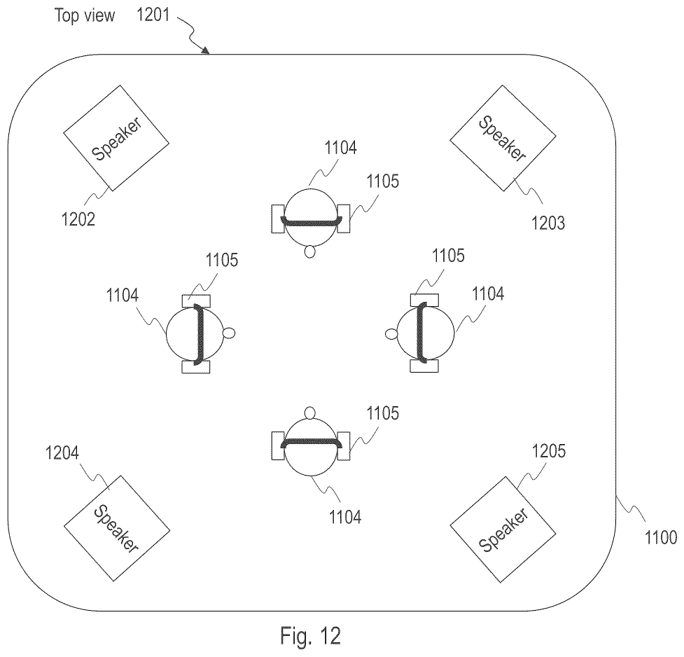

FIG. 12 illustrates a second example of the test room for performing the acoustic quality evaluation according to the first embodiment.

A numerical reference 1201 is a top view of the soundproof room 1100. In the soundproof room, a plurality of the evaluators 1104 wearing open type headphones 1105 are located, a plurality of the speakers are disposed, and the ambient noise is output from the speakers. FIG. 12 illustrates an example in which four speakers 1202, 1203, 1204, and 1205 are disposed.

It is desirable that the speakers 1202 to 1205 are sufficiently separated from the evaluators 1104 and installed at the upper portions of the soundproof room 1100.

All the speaker outputs may be the same sound (monaural sound) or a stereo sound. In both cases, S/N and volume level are measured near the ears of the evaluators 1104.

Note that in a case where the stereo sound is used, the number of speakers is set to an even number, and the speaker that outputs the left channel and the speaker that outputs the right channel are alternately disposed along the wall of the soundproof room. In the case of FIG. 12, for example, the left-channel sound is output from the speakers 1202 and 1205, and the right-channel sound is output from the speakers 1203 and 1204.

It is desirable that the evaluators 1104 are located at the center in a plurality of the speakers 1202 to 1205, but the position of each of the evaluators 1104 may not necessarily be at the center in a plurality of the speakers 1202 to 1205 as long as the evaluator is sufficiently away from the speakers.

When the speakers 1202 to 1205 are disposed and the evaluators 1104 are located in this manner, a plurality of people can listen to the sound simultaneously.

### <Third Example Of Test Room>

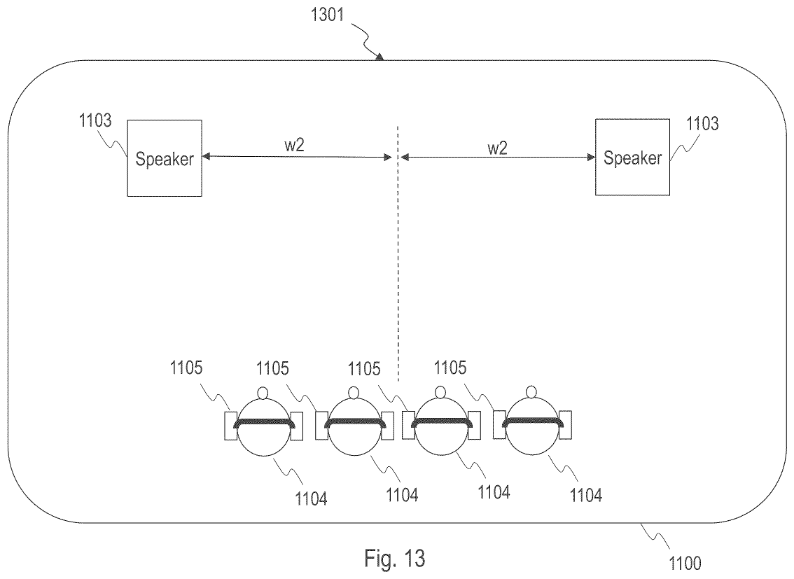

FIG. 13 illustrates a third example of the test room for performing the acoustic quality evaluation according to the first embodiment.

A numerical reference 1301 is a top view of the soundproof room 1100. In the soundproof room, a plurality of the evaluators 1104 wearing open type headphones 1105 are located, a plurality of the speakers 1103 are disposed, and the ambient noise is output from the speakers 1103.

It is desirable that the speakers 1103 are sufficiently separated from the evaluators 1104 and installed at positions equal to or higher than the height of the ears of the evaluators 1104.

All outputs of the speakers 1103 may be the same sound (monaural sound) or a stereo sound. In both cases, S/N and volume level are measured near the ears of the evaluators 1104.

It is desirable that the evaluators 1104 are located at a substantially equal distances from a plurality of the speakers 1103, but the positions of the evaluators 1104 may not necessarily be at equal distances from a plurality of the speakers as long as the evaluators are sufficiently away from the speakers 1103.

When the speakers 1103 are disposed and the evaluators 1104 are located in this manner, a plurality of people can listen to the sound simultaneously.

Although the first embodiment of the disclosed technique has been described in the order of the specific examples of the data generation apparatus, the acoustic quality evaluation apparatus, and the listening test room, the disclosed technique may include some modification examples.

For example, in the first embodiment, the ambient noise signals are separately prepared for the near-end and the far-end, but in order to generate data for an evaluation test, the ambient noise signals for the near-end and the far-end may be supplied from a common noise signal storage.

Furthermore, in order to faithfully simulate the loudspeaker hands-free communication system in the noise environment, in the first embodiment, the voice that is the source of the acoustic echo signal is transmitted from the near-end to the far-end. However, for the listening test in the noise environment, only the far-end voice superimposed with the ambient noise at the far-end may be received at the near-end, and the listening test may be performed under the noise environment at the near-end. In this case, the evaluator does not need to be supplied with the near-end voice or the like that is the source of the acoustic echo signal.

### <Combination of Open Type Headphones and Speaker>

The following provides a supplementary explanation regarding the fact that the disclosed technique employs a configuration in which the evaluation sound is supplied from the open type headphones and the ambient noise is supplied from the speaker disposed around the evaluator.

The disclosed technique aims to evaluate a “communication sound output from a speaker of a loudspeaker hands-free communication system under a noise environment”, and performs a listening evaluation by simulating the environment.

In the real environment, the ambient noise and the evaluation target sound generally occur at different locations. In such a case, a human can distinguish between the ambient noise and the evaluation target sound by the cocktail party effect.

As a method of simulating the noise environment, a method of electronically mixing the ambient noise and the evaluation target sound and supplying the mixture to the headphones can be considered, but in this case, a situation is made in which the ambient noise and the evaluation target sound are generated at the same location. It is not easy for the human to separate a plurality of sounds generated at the same location. For example, since the evaluation target sound is buried in the noise, it is difficult to obtain a stable evaluation value.

On the other hand, in the disclosed technique, the ambient noise is supplied from a speaker (out-of-head localization), and the evaluation target sound is supplied from headphones (inside-head localization). By respectively supplying sounds through different apparatuses, a situation in which the ambient noise and the evaluation target sound are generated at different locations is simulated. As a result, a cocktail party effect is obtained, the ambient noise and the evaluation target sound can be distinguished, and a stable evaluation value can be obtained.

### [Program and Recording Medium]

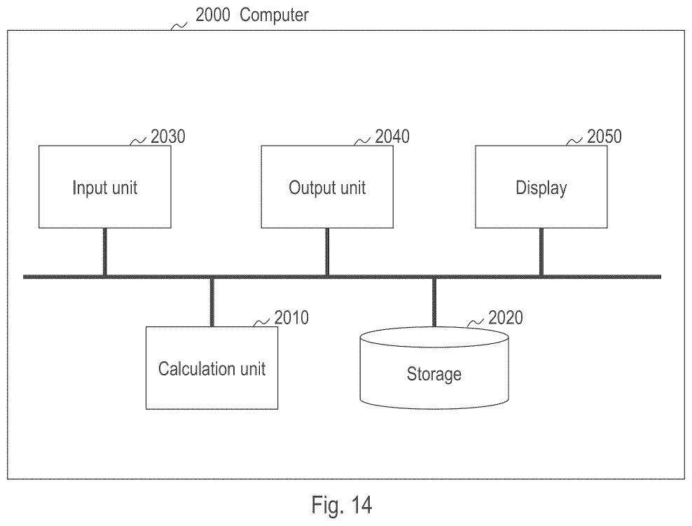

The various types of processing described above can be performed by causing a storage 2020 of a computer 2000 illustrated in FIG. 14 to read a program for executing steps of the method described above and causing a calculation unit 2010, an input unit 2030, an output unit 2040, a display 2050, and the like to operate.

The program in which the processing content is written may be recorded on a computer-readable recording medium. The computer-readable recording medium may be, for example, any recording medium such as a magnetic recording device, an optical disk, a magneto-optical recording medium, or a semiconductor memory.

Furthermore, the distribution of the program is performed by, for example, selling, transferring, or rending a portable recording medium such as a DVD or a CD-ROM in which the program is recorded. Moreover, the program may be stored in a storage of a server computer, and the program may be distributed by transferring the program from the server computer to another computer via a network.

For example, a computer that executes such a program first temporarily stores a program recorded on a portable recording medium or a program transferred from the server computer in a storage of the computer. Then, when executing processing, the computer reads the program stored in its storage and executes the processing according to the read program. Furthermore, as another mode of executing the program, the computer may read the program directly from the portable recording medium and execute the processing according to the program, or may sequentially execute processing according to a received program every time the program is transferred from the server computer to the computer. Furthermore, the above-described processing may be executed by a so-called application service provider (ASP) type service that implements a processing function only by an execution instruction and result acquisition without transferring the program from the server computer to the computer. Note that the program described herein includes information used for processing by an electronic computer and equivalent to the program (data or the like that is not a direct command to the computer but has a property that defines processing of the computer).

Furthermore, although the present devices are each configured by executing a predetermined program on a computer in the description above, at least part of the processing content may be implemented by hardware.

1. An acoustic quality evaluation apparatus that evaluates an acoustic quality of a loudspeaker hands-free communication system including a first terminal and a second terminal, the acoustic quality evaluation apparatus comprising:
a data storage that records an evaluation target sound which is captured by the first terminal and received by the second terminal;
an acoustic output processor that outputs the evaluation target sound to a head-mounted open type acoustic apparatus; and
a noise output processor that outputs ambient noise surrounding the open type acoustic apparatus.

2. The acoustic quality evaluation apparatus according to claim 1,
wherein the evaluation target sound is a first degraded sound obtained by superimposing an accompanying sound that includes an acoustic echo signal and/or the ambient noise of the first terminal on a voice of a user of the first terminal, or a second degraded sound obtained by performing signal processing on a sound obtained by superimposing an accompanying sound that includes an acoustic echo signal and/or the ambient noise of the first terminal on a voice of a user of the first terminal.

3. (canceled)

4. The acoustic quality evaluation apparatus according to claim 2,
wherein a non-degraded sound that is the voice of the user of the first terminal and is not accompanied by the accompanying sound is further recorded in the data storage, and
the acoustic output processor sequentially outputs the non-degraded sound and the evaluation target sound.

5. An acoustic quality evaluation method for evaluating an acoustic quality of a loudspeaker hands-free communication system including a first terminal and a second terminal, the acoustic quality evaluation method comprising:
recording an evaluation target sound which is a sound captured by the first terminal and received by the second terminal in a data storage;
outputting the evaluation target sound to a head-mounted open type acoustic apparatus from an acoustic output processor; and
outputting ambient noise surrounding the open type acoustic apparatus from a noise output processor.

6. The acoustic quality evaluation method according to claim 5,
wherein the evaluation target sound is a first degraded sound obtained by superimposing an accompanying sound that includes an acoustic echo signal and/or the ambient noise of the first terminal on a voice of a user of the first terminal, or a second degraded sound obtained by performing signal processing on a sound obtained by superimposing an accompanying sound that includes an acoustic echo signal and/or the ambient noise of the first terminal on a voice of a user of the first terminal.

7. (canceled)

8. The acoustic quality evaluation method according to claim 6, comprising recording a non-degraded sound that is the voice of the user of the first terminal and is not accompanied by the accompanying sound in the data storage,
wherein the outputting, by the acoustic output processor, the evaluation target sound is sequentially outputting the non-degraded sound and the evaluation target sound.

9. A non-transitory computer-readable recording medium which stores a program for causing a computer to function as the acoustic quality evaluation apparatus according to claim 1.
